(19) United States
(12) Patent Application Publication
(10) Pub. No.: US 2026/0149194 A1
(43) Pub. Date: May 28, 2026

(54) TERMINAL ASSEMBLY AND ELECTRICAL CONNNECTOR

(71) Applicant: Tyco Electronics (Shanghai) Co., Ltd., Shanghai (CN)

(72) Inventors: Jiaoyong (Mac) Liu, Shanghai (CN); Jie (Roger) Luo, Foshan (CN); William (Wei) Yao, Kunshan (CN); Rong (Summer) Zhang, Shenzhen (CN)

(73) Assignee: Tyco Electronics (Shanghai) Co., Ltd., Shanghai (CN)

(21) Appl. No.: 19/401,962

(22) Filed: Nov. 26, 2025

(30) Foreign Application Priority Data
Nov. 27, 2024 (CN) 202411721337.1

(51) Int. Cl. H01R 4/48

(52) U.S. Cl. CPC H01R 4/4811; H01R 4/484

(57) ABSTRACT

A terminal assembly configured to fit with a conductive member to form a conductive contact therebetween. The terminal assembly comprises a terminal base and a contact arm fixed to the terminal base. The contact arm includes a common base plate fixed to the terminal base. The contact arm further includes two sets of contact beams arranged in mirror symmetry with each other relative to a longitudinal axis of the common base plate, with each set of contact beams being constructed to extend from a respective side of the common base plate and to bend back.

### CROSS-REFERENCE TO RELATED APPLICATIONS

This application claims the benefit of Chinese Patent Application No. CN202411721337.1 filed on Nov. 27, 2024 in the State Intellectual Property Office of China, the whole disclosure of which is incorporated herein by reference.

### FIELD OF THE INVENTION

The present disclosure generally relates to the technical field of conductive connectors, and more particularly, to a terminal assembly and an electrical connector.

### BACKGROUND OF THE INVENTION

Electrical connectors are electronic components that transmit and exchange currents or signals between electronic system devices. Electrical connectors, as nodes, independently or together with cables, transmit currents or signals between devices, assemblies, apparatuses, and systems, and maintain an absence of signal distortion and variations in energy loss between the systems. They are essential basic elements necessary for constructing complete interconnection of the entire system.

There exists a mutual assembly relationship between a Power Supply Unit (PSU) or a Battery Backup Unit (BBU) functioning as a power source and a Power Shelf Bus Bar. Among others, a connector for electrically connecting electrodes of the power supply to the bus bar is typically laid down in a horizontal arrangement, and a slot is formed on the connector, into which slot the electrodes of the power supply are adapted to be inserted as an insert, for example in a form of conductive gold fingers arranged on both sides for opposite polarities, so as to achieve an electrical connection between, for example, a horizontal copper bar and a rack busbar via the insert.

Once lengths of the PSU and BBU in an existing cabinet increase due to an increase in the system power, then the length of the rack bus bars increase while an overall size of the cabinet remains unchanged, resulting in a need to greatly compress dimensions of the electrical connector and horizontal copper bars in the lengthwise direction. Given the dimensions of the horizontal copper bars change little or even remain substantially constantly, and since the electrical connector is laid down horizontally, then it is necessary to compress a height of the electrical connector from the bottom thereof to an opening thereof into which the insert is to be inserted. Moreover, since electrical connector products need to be installed in a highly confined space, there exits a need to correspondingly improve a current-carrying capacity while maintaining a resilient contact capacity between terminal(s) and the insert, in the electrical connector.

There is an urgent need for an improved terminal assembly and an electrical connector comprising the terminal assembly, which need may be achieved, for example, by an improvement in the assembly structure, such that, on the one hand, the height between the bottom of the electrical connector and top opening of the connector for insertion of the insert, can be effectively compressed; on the other hand, the electrical connector product can maintain the elastic contact performance between the terminal(s) and the insert in the electrical connector in a space having limited size, while reducing a risk of terminal yielding; and also realizing a adjustable elastic force of the terminal, as well as improving the current-carrying capacity of the terminal.

### SUMMARY OF THE INVENTION

The terminal assembly configured to fit with a conductive member to form a conductive contact therebetween, and the terminal assembly includes a terminal base and a contact arm fixed to the terminal base. The contact arm includes a common base plate fixed to the terminal base, and two sets of contact beams arranged in mirror symmetry with each other relative to a longitudinal axis of the common base plate, with each set of contact beams being constructed to extend from a respective side of the common base plate and to bend back.

According to a first aspect of the disclosure, there is provided a terminal assembly configured to fit with a conductive member to form a conductive contact therebetween, and the terminal assembly comprises a terminal base and a contact arm fixed to the terminal base. The contact arm comprises: a common base plate fixed to the terminal base, and two sets of contact beams arranged in mirror symmetry with each other relative to a longitudinal axis of the common base plate, with each set of contact beams being constructed to extend from a respective side of the common base plate and to bend back.

According to the exemplary embodiments disclosed herein, respective thicknesses of the terminal base and the contact arm are individually configurable, independently of each other.

According to the exemplary embodiments disclosed herein, respective free ends of the two sets of contact beams are spaced apart from each other.

According to the exemplary embodiments disclosed herein, each set of contact beams comprises a row of contact fingers arranged to be spaced apart from each other along the longitudinal axis, the row of contact fingers being configured to extend from the respective side of the common base plate away from the common base plate above all, and then bend back, respectively.

According to the exemplary embodiments disclosed herein, respective contact fingers of the two sets of contact beams are equal in quantity, and are disposed to be opposite each other.

According to the exemplary embodiments disclosed herein, the free ends of the respective contact fingers of the two sets of contact beams are spaced apart from each other.

According to the exemplary embodiments disclosed herein, each contact finger is provided with a first bending point and a second bending point, each contact finger extending from the common base plate away from the longitudinal axis until it reaches the first bending point, and then bending back towards a respective opposite contact finger, and each contact finger continuing to extend from the first bending point until it reaches the second bending point and being further bent toward the longitudinal axis at the second bending point; and each contact finger comprises: a first beam section located between a side edge of the common base plate and the first bending point and attached to the common base plate; a second beam section located between the first bending point and the second bending point; and a third beam section located between the third bending point and the free end.

According to the exemplary embodiments disclosed herein, in a condition that the conductive element is fitted to the terminal assembly: the conductive element urges each contact finger of each of the two sets of contact beams of the contact arm toward the common base plate; the first bending point of each contact finger functions as a pivot point for the second beam section and the third beam section of the contact finger to pivot relative to the first beam section under a pushing action of the conductive member; and the second bending point of each contact finger functions as a conductive contact point at which the terminal assembly and the conductive component are in conductive contact with each other.

According to the exemplary embodiments disclosed herein, respective contact fingers of the two sets of contact beams are arranged in one-to-one alignment with each other; or respective contact fingers of the two sets of contact beams are arranged to be incompletely aligned with each other.

According to the exemplary embodiments disclosed herein, the common base plate and the two sets of contact beams are integrally formed from an electrically conductive sheet material.

According to the exemplary embodiments disclosed herein, the common base plate and the two sets of contact beams are made of sheet metal by a sheet metal process.

According to the exemplary embodiments disclosed herein, the terminal base comprises: a plate-shaped base portion extending in a first direction orthogonal to the longitudinal axis; and a plate-shaped extension portion bent from the plate-shaped base portion to extend in a second direction at an angle to both the first direction and the longitudinal axis.

According to the exemplary embodiments disclosed herein, the second direction is orthogonal to both the first direction and the longitudinal axis.

According to the exemplary embodiments disclosed herein, both ends of the common base plate of the contact arm along the longitudinal axis are respectively provided with holes for riveting or screwing to the terminal base, the common base plate being fixed to the plate-shaped extension portion of the terminal base via riveting or screwing at the holes.

According to a first aspect of the disclosure, there is provided an electrical connector, comprising: an insulating housing, which is provided with a terminal accommodating portion; and two terminal assemblies each according to any one of claims 1 to 14, each terminal assembly being fixed to the housing by snap-fitting to the terminal base in the terminal accommodating portion, respectively. The two terminal assemblies are accommodated in the terminal accommodating portion of the housing and arranged opposite each other, and are electrically connected to both sides of the conductive member which have different potentials or polarities and are interposed between the two terminal assemblies, respectively.

According to the exemplary embodiments disclosed herein, each of the two terminal assemblies has a tab, which extends obliquely away from the conductive member toward the housing from respective edge at respective end of both ends of the terminal base in a direction parallel to the longitudinal axis, respectively.

According to the exemplary embodiments disclosed herein, each tab is arranged obliquely to extend outward away from the conductive member toward an inner wall of the terminal accommodating portion of the housing from a respective edge of the terminal base, such that, each tab functions as a stop to prevent a respective terminal assembly from exiting the terminal accommodating portion of the housing, in a condition that the two terminal assemblies are mounted in place in the terminal accommodating portion of the housing.

According to the exemplary embodiments disclosed herein, in response to the two terminal assemblies being mounted in place in the terminal accommodating portion of the housing without being offset by force, each tab does not contact the inner wall of the terminal accommodating portion; and in response to at least one terminal assembly being displaced in the terminal accommodating portion, at least one tab is urged against the inner wall of the terminal housing and functions as a beam with simply-supported end supporting respective terminal assembly relative to the inner wall.

According to the exemplary embodiments disclosed herein, the housing comprises two bodies disposed opposite each other, the two bodies being spaced apart to define a through cavity which extends along the longitudinal axis therebetween for insertion of the conductive member and the two bodies being merely connected at respective bottoms thereof, each body being provided with a through-hole portion formed at the respective bottom for insertion of a respective terminal assembly, and each body being provided with a recess recessed at a side facing the other body, the through-hole portion of each body communicating to respective recess for receiving the respective terminal assembly, with respective recesses of the two bodies cooperatively defining the terminal accommodating portion.

According to the exemplary embodiments disclosed herein, the two bodies are connected to each other at respective bottoms, by their respective end walls at both ends along the longitudinal axis via a transition wall portion therebetween.

According to the exemplary embodiments disclosed herein, the electrical connector further comprises a substrate to which the terminal base of each terminal assembly is secured.

### BRIEF DESCRIPTION OF DRAWINGS

In the following, the present invention is described in more detail with references to the drawings in which:

FIGS. 1A-1C illustrate two schematic perspective views and a schematic exploded view, respectively, from different viewing angles of an exemplary terminal assembly according to an embodiment of the present disclosure;

FIGS. 2A-2D illustrate a schematic perspective view, a front view, a left view, and a top view, of an exemplary electrical connector according to an embodiment of the present disclosure;

FIG. 2E illustrates a cross-sectional view taken along line A-A in FIG. 2D;

FIG. 2F illustrates a schematic view taken along line B-B in FIG. 2D;

FIG. 2G illustrates a schematic exploded view of FIG. 2A in which the two terminal assemblies are assembled with the housing;

FIG. 3 illustrates a partially exploded view of the two terminal assemblies and the housing in an assembled state as shown in FIG. 2G; and

FIGS. 4A and 4B respectively illustrate schematic perspective views from different viewing angles of the housing as shown in FIG. 3.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

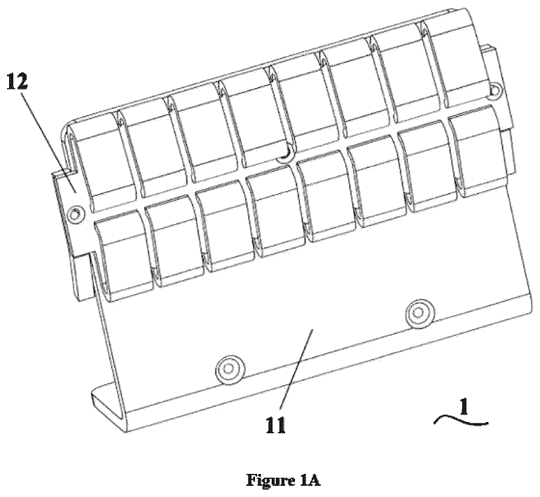

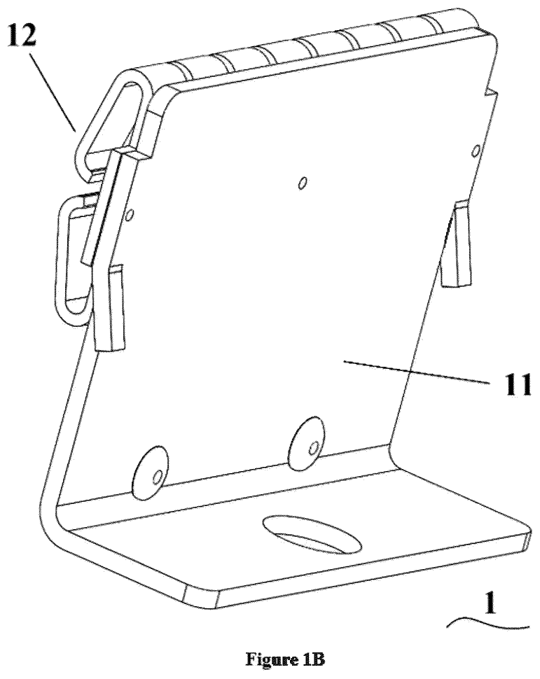

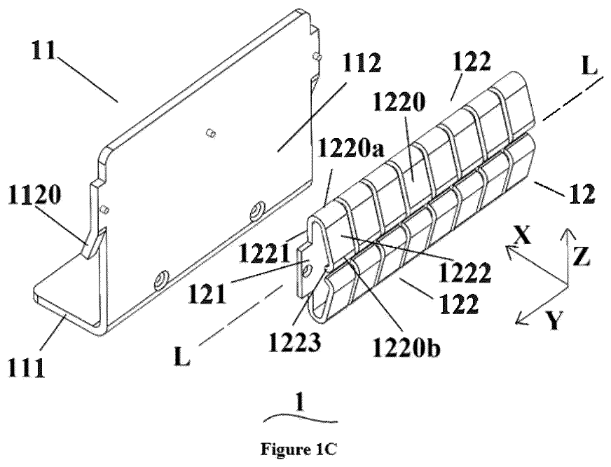

In the exemplary embodiment, FIGS. 1A-1C illustrate two schematic perspective views and a schematic exploded view, respectively, from different viewing angles of an exemplary terminal assembly according to an embodiment of the present disclosure.

In the exemplary embodiment, in one aspect of the present disclosure, according to a general technical concept of the present disclosure, for example, as shown in FIGS. 1A to 1C, there is provided a terminal assembly 1 configured to fit with a conductive contact with a conductive member 6 to form a conductive contact therebetween, and the terminal assembly 1 comprises a terminal base 11 and a contact arm 12 fixed to the terminal base 11. As an exemplary embodiment, for example as illustrated, the contact arm 12 comprises: a common base plate 121, fixed to the terminal base 11, and two sets of contact beams 122 arranged in mirror-symmetry with each other relative to a longitudinal axis L of the common base plate 121, with each set of contact beams 122 being configured to extend from a respective side of the common base plate 121 and be bent back, the longitudinal axis L being illustrated for example as the Y direction. As an example, the contact arm 12 is riveted to the terminal base 11, for example via the common base plate 121.

With this arrangement, for example, with the two sets of contact beams 122 arranged in mirror-symmetry with each other relative to the longitudinal axis L of the common base plate 121 each contact beam 122 extending outwardly above all and then bending back, thereby substantially defining pairs of opposed folded beams, as such, a significant increase in equivalent cantilever length at the contact beam 122 is achieved (in the case of a limited dimension in height direction, i.e. Z dimension as illustrated); and in turn, upon consideration of a fact that a total equivalent cantilever length essentially equals a sum of a vertical length (e.g., a length in the Z direction as illustrated) of the terminal base 11 portion and equivalent cantilever lengths at the two sets of contact beams 122, then, the total equivalent cantilever length for the terminal assembly 1 is correspondingly significantly increased, thereby at least partially alleviating, or even completely avoiding problems, for example, overly short cantilever caused by the use of conventional cantilever beams in case of restricted dimension in the height direction, which overly short cantilever may easily induce a yielding risk and in turn a loss of the terminal's elastic contact effectiveness.

According to an exemplary embodiment of the present disclosure, for example, respective thicknesses of the terminal base 11 and the contact arm 12 are individually configurable, independently of each other.

Accordingly, based on this arrangement, as compared to relevant terminal assemblies 1, for example, each having a plurality of groups of terminals in a “staggered and overlapped” configuration, upon consideration that the higher the current-carrying capacity of the terminals is, the larger the thickness thereof may be required, then, an elastic force of the cantilever beam of the terminal assembly 1, for example, having a cubic relationship with the thickness, should also be correspondingly larger. Then it is difficult for these relevant terminal assemblies 1 to correspondingly meet requirements of larger elastic forces and larger current-carrying capacity, for example due to limitation of factors of terminal thickness. However, in the exemplary terminal of the present disclosure, since the respective thicknesses of the terminal base 11 and the contact arm 12 are individually configurable, then the thickness of the terminal base 11 can be individually increased while maintaining the thicknesses of the contact arm 12 unchanged, particularly maintaining the thicknesses of the two sets of contact beams 122 thereof unchanged, such that the effects of improving the current carrying capacity of the terminal assembly 1 and maintaining the elastic force of terminal can be effectively achieved without changing respective thicknesses of all components of the exemplary terminal assembly 1 of the present disclosure. As such, it is possible to effectively adjust the elastic force and elastic contact efficiency of the terminal assembly 1, merely by adjusting the thickness of the terminal base 11 portion, regardless of the variation of the thickness of the contact beam 122 portion.

According to an exemplary embodiment of the present disclosure, for example as illustrated, respective free ends of the two sets of contact beams 122 are spaced apart from each other. Thus, with this arrangement, it is substantially realized that, when the two sets of contact beams 122 in the contact arm 12 of the single terminal assembly 1 electrically contact a same conductive location, then they are substantially formed in a parallel conduction on both sides of the common base plate 121, thereby contributing to a multiplication of conductive paths, and in turn achieving an improved current-carrying capacity in a limited space.

In a further embodiment, as illustrated, by way of specific example, each set of contact beams 122 comprises a row of contact fingers 1220 arranged to be spaced apart, for example at uniform interval, from each other along the longitudinal axis L, the row of contact fingers 1220 being configured to extend from the respective side of the common base plate 121 away from the common base plate 121 above all, and then bend back, respectively. As compared to relevant terminal assemblies 1, for example, each having a plurality of groups of terminals in a “staggered and overlapped” configuration, this further facilitates a multiplication of conductive paths and achieves increased current-carrying capacity within a limited space, while the area of the conductive paths can be significantly increased. It should be noticed that, relevant terminal assemblies 1 each having a plurality of groups of terminals in a “staggered and overlapped” configuration can achieve an effect of conductive paths being routed in two layers of conductive terminals, however, the area of their conductive paths may be significantly smaller than that of the aforementioned exemplary terminal assembly 1 of the present disclosure in terms of an conductive contact interface.

In the exemplary embodiment, for example as illustrated, respective contact fingers 1220 of the two sets of contact beams 122 are equal in quantity, and are disposed to be opposite each other, thereby achieving convenient manufacturing and assembly, and facilitating mechanical and electrical calculations during design in a simplified manner.

By way of example, as illustrated, the free ends of the respective contact fingers 1220 of the two sets of contact beams 122 are spaced apart from each other.

According to a further exemplary embodiment of the present disclosure, for example as illustrated, each contact finger 1220 is provided with a first bending point 1220a and a second bending point 1220b, each contact finger 1220 extending from the common base plate 121 away from the longitudinal axis L until it reaches the first bending point 1220a, and then bending back towards a respective opposite contact finger 1220, and each contact finger 1220 continuing to extend from the first bending point 1220a until it reaches the second bending point 1220b and being further bent toward the longitudinal axis L at the second bending point 1220b. Accordingly, for example, each contact finger 1220 comprises: a first beam section 1221 located between a side edge of the common base plate 121 and the first bending point 1220a and attached to the common base plate 121; a second beam section 1222 located between the first bending point 1220a and the second bending point 1220b; and a third beam section 1223 located between the third bending point and the free end.

In a further embodiment, as illustrated as a specific example, in a condition that the conductive element 6 is fitted to the terminal assembly 1: the conductive element 6 urges each contact finger 1220 of each of the two sets of contact beams 122 of the contact arm 12 toward the common base plate 121; the first bending point 1220a of each contact finger 1220 functions as a pivot point for the second beam section 1222 and the third beam section 1223 of the contact finger 1220 to pivot relative to the first beam section 1221 under a pushing action of the conductive member 6; and the second bending point 1220b of each contact finger 1220 functions as a conductive contact point at which the terminal assembly 1 and the conductive component 6 are in conductive contact with each other.

With this arrangement, for all contact fingers 1220 in each set of contact beams 122, their respective first bending points 1220a collectively function to essentially define a pivot axis about which that set of contact beams 122 pivots under pushing action of the contacted conductive member 6 towards the common base plate 121. This pivot axis is defined by an alignment of these first bending points 1220a into a line, whereby respective second beam sections 1222 of all contact fingers 1220 in that set of contact beams 122 pivot toward the longitudinal axis L, and the connected third beam sections 1223 in turn pivot toward the longitudinal axis L, until the respective second bending points 1220b of all contact fingers 1220 in that set sufficiently contact against the respective electrical contact portion of the conductive member 6. Thereby, the respective second bending points 1220b of that set of contact beams 122 effectively function as reliable conductive contact points with the conductive member 6. As such, this achieves reliable electrical connection between that set of contact beams 122 and the conductive member 6.

As an optional exemplary embodiment, respective contact fingers 1220 of the two sets of contact beams 122 are arranged in one-to-one alignment with each other, thereby achieving simplified design and its mechanical and electrical calculations, as well as simple processing and assembly. Alternatively, as an alternative exemplary embodiment, respective contact fingers 1220 of the two sets of contact beams 122 may also be arranged to be incompletely aligned with each other along the longitudinal axis L, or even slightly offset to be partially aligned, or even completely mis-aligned or staggered.

In an exemplary embodiment of the present disclosure, for example, the common base plate 121 and the two sets of contact beams 122 are integrally formed from an electrically conductive sheet material. In a further more specific embodiment, for example, the common base plate 121 and the two sets of contact beams 122 are made of sheet metal by a sheet metal process. This enables simple processing and manufacturing using conventional processes.

In another exemplary embodiment, as illustrated in a specific arrangement, the terminal base 11 comprises, for example: a plate-shaped base portion 111 extending in a first direction X orthogonal to the longitudinal axis L; and a plate-shaped extension portion 112 bent from the plate-shaped base portion 111 to extend in a second direction Z at an angle to both the first direction X and the longitudinal axis L. In a typical embodiment, for example, the second direction Z is orthogonal to both the first direction X and the longitudinal axis L.

Thereby, the plate-like base 111 of the terminal base 11 functions as a mounting reference for the entire terminal assembly 1, for example as illustrated, the contact arm 12 is riveted or screwed to the plate-shaped extension portion 112 of the terminal base 11, for example via the common base plate 121. Furthermore, the equivalent cantilever length of the terminal base 11 can be considered substantially equal to the vertical height of the plate-like extension 112 to which the contact arm 12 is fixed, for example via its common base plate 121, and the entire terminal assembly 1 is then fixed via the plate-like base 111 to the working location to be mounted.

In an exemplary embodiment, for example as illustrated, both ends of the common base plate 121 of the contact arm 12 along the longitudinal axis L are respectively provided with holes for riveting or screwing to the terminal base 11, the common base plate 121 being fixed to the plate-shaped extension portion 112 of the terminal base 11 via riveting or screwing at the holes.

Based on the terminal assembly 1 as provided above, superior technical effects over existing technical solutions in the art may be realized, as follows:
Based on the structure and assembly arrangement of such a terminal assembly 1, it is not only possible to utilize the two sets of contact beams 122 arranged in mirror-symmetry with each other relative to the longitudinal axis L of the common base plate 121 (each contact beam 122 extending outwardly above all and then bending back, thereby substantially defining pairs of opposed folded beams), as such, a significant increase in equivalent cantilever length at the contact beam 122 is achieved (in the case of a limited dimension in height direction, i.e. Z dimension as illustrated); and in turn, upon consideration of a fact that a total equivalent cantilever length essentially equals a sum of a vertical length (e.g., a length in the Z direction as illustrated) of the terminal base 11 portion and equivalent cantilever lengths at the two sets of contact beams 122, then, the total equivalent cantilever length for the terminal assembly 1 is correspondingly significantly increased, thereby at least partially alleviating, or even completely avoiding problems, for example, overly short cantilever caused by the use of conventional cantilever beams in case of restricted dimension in the height direction, which overly short cantilever may easily induce a yielding risk and in turn a loss of the terminal's elastic contact effectiveness; further, it is but also possible that the respective thicknesses of the terminal base 11 and the contact arm 12 are individually configurable, independently of each other—as such, it is possible to effectively adjust the elastic force and elastic contact efficiency of the terminal assembly 1, merely by adjusting the thickness of the terminal base 11 portion, regardless of the variation of the thickness of the contact beam 122 portion.

Furthermore, as compared to relevant terminal assemblies 1, for example, each having a plurality of groups of terminals in a “staggered and overlapped” configuration, the terminal assembly 1 of the present disclosure further facilitates a multiplication of conductive paths and achieves increased current-carrying capacity within a limited space, while the area of the conductive paths can be significantly increased. Consequently, improved elastic contact properties, adjustable elastic force, and enhanced current-carrying capacity are achieved.

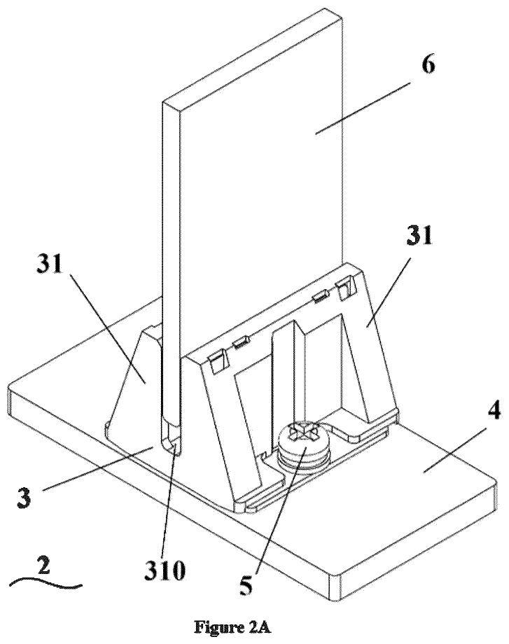

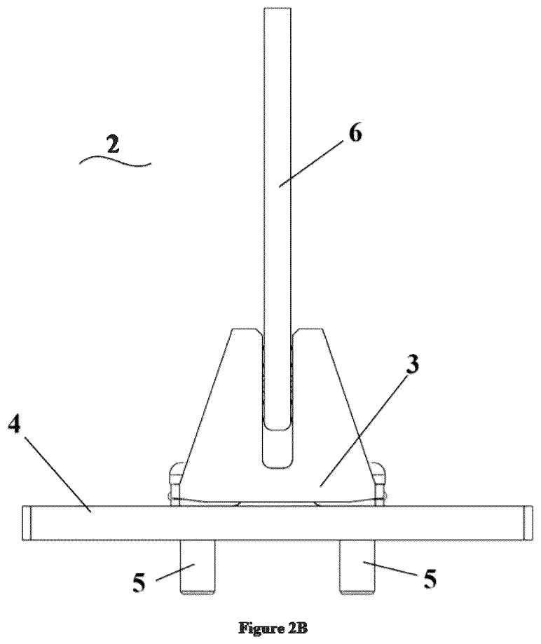

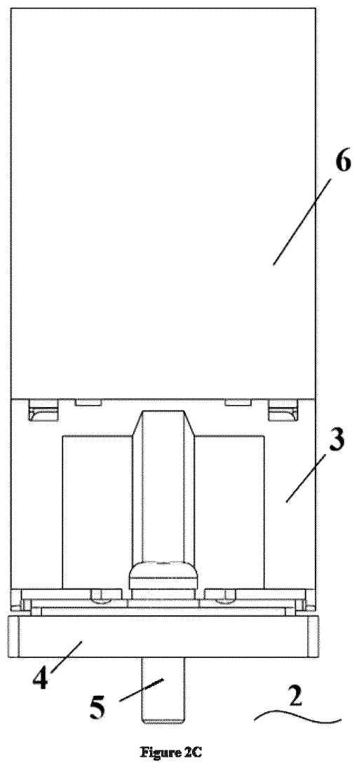

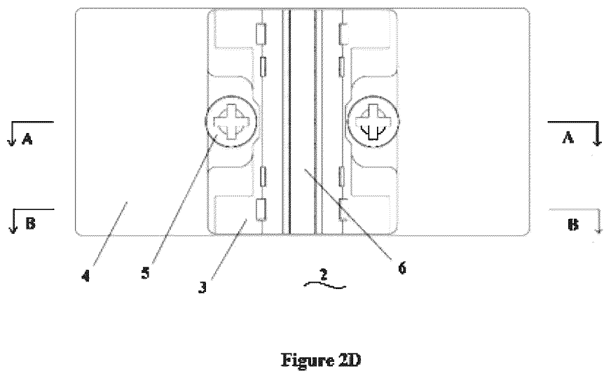

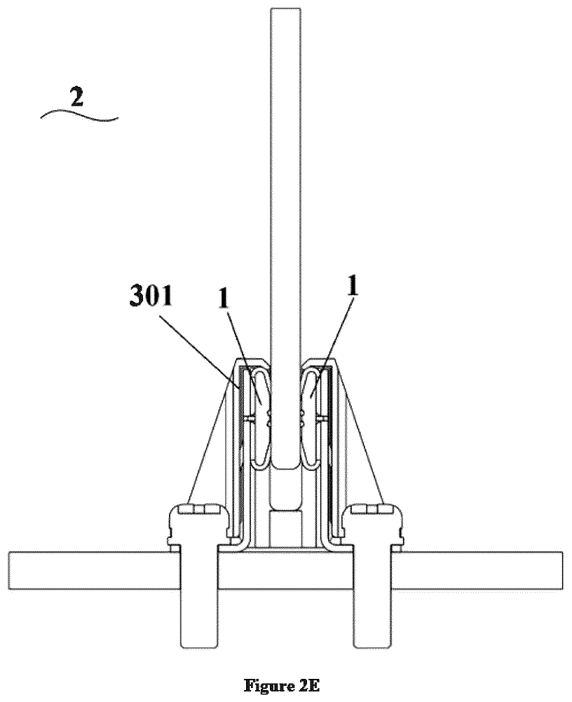

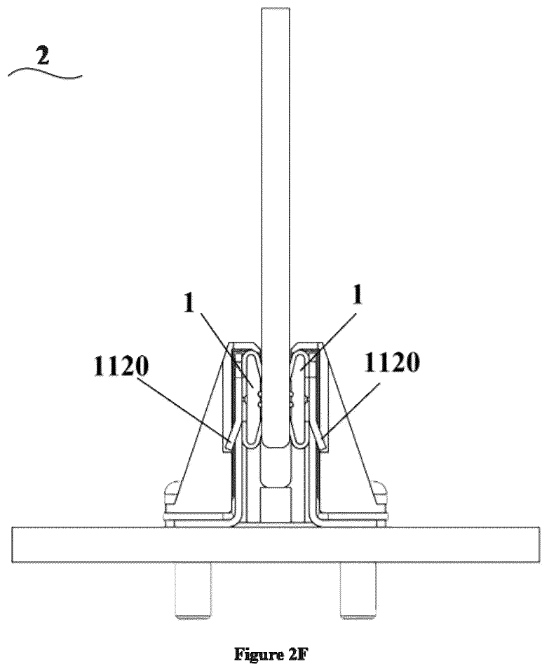

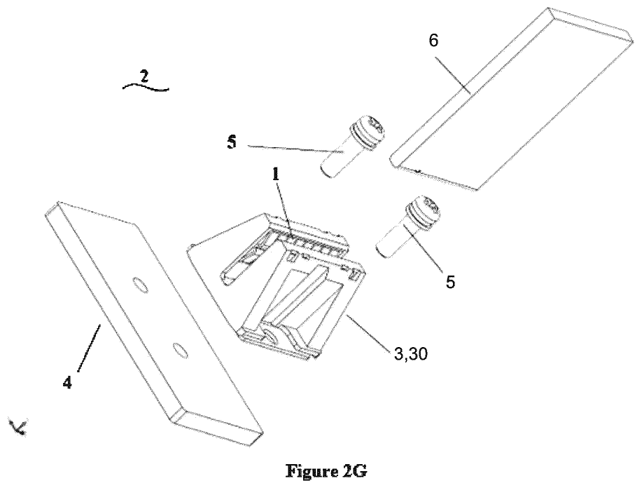

In the exemplary embodiment, FIGS. 2A-2D illustrate a schematic perspective view, a front view, a left view, and a top view, of an exemplary electrical connector according to an embodiment of the present disclosure; FIG. 2E illustrates a cross-sectional view taken along line A-A in FIG. 2D; FIG. 2F illustrates a schematic view taken along line B-B in FIG. 2D; FIG. 2G illustrates a schematic exploded view of FIG. 2A in which the two terminal assemblies 1 are assembled with the housing 3.

In an exemplary embodiment, according to a general technical concept of the present disclosure, for example, as shown in the figures, there is further provided an electrical connector 2, comprising: an insulating housing 3, which is provided with a terminal accommodating portion 30; and two terminal assemblies 1 each as described above, each terminal assembly 1 being fixed to the housing 3 by snap-fitting to the terminal base 11 in the terminal accommodating portion 30, respectively. By way of example, the two terminal assemblies 1 are accommodated in the terminal accommodating portion 30 of the housing 3 and arranged opposite each other, and are electrically connected to both sides of the conductive member 6 which have different potentials or polarities and are interposed between the two terminal assemblies 1, respectively. Thereby, a complete conductive path with opposite polarities on the two terminal assemblies 1 respectively is established.

In an exemplary embodiment, for example as illustrated, once each terminal assembly 1 is received in place in the terminal accommodating portion 30 of the housing 3 and, for example, snap-fitted into the terminal accommodating portion 30, since the contact arm 12 is fixed to the plate-shaped extension portion 112, for example via its common base plate 121, and then the plate-shaped extension portion 112 of each terminal assembly 1 is riveted or screwed to a wall portion at the terminal accommodating portion 30, the two terminal assemblies 1 are fixedly attached to the housing 3, respectively.

In an exemplary embodiment according to the present disclosure, for example as illustrated, the electrical connector 2 further comprises a substrate 4 to which the terminal base 11 of each terminal assembly 1 is fixed.

In a more specific exemplary embodiment, for example, as shown in the figure, threaded holes are formed in the plate-shaped base portion 111 of the terminal base 11 of each terminal assembly 1. Once each terminal assembly 1 is received in place in the terminal accommodating portion 30 of the housing 3, respective threaded fasteners 5 screwed through respective threaded holes of the plate-shaped base portion 111 of each of the two terminal assemblies 1 securely fix the plate-shaped base portion 111 of each terminal assembly 1 to the substrate 4. Thereby, the two terminal assemblies 1 and the housing 3 are all fixed in place relative to the substrate 4.

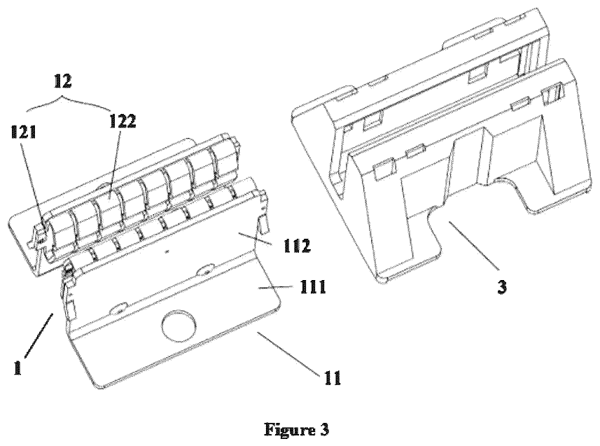

In the exemplary embodiment, FIG. 3 illustrates a partially exploded view of the two terminal assemblies 1 and the housing 3 in an assembled state as shown in FIG. 2G.

According to a typical exemplary embodiment of the present disclosure, for example as shown in the figures, each of the two terminal assemblies 1 has a tab 1120, which extends obliquely away from the conductive member 6 toward the housing 3 from respective edge at respective end of both ends of the terminal base 11 in a direction Y parallel to the longitudinal axis L, respectively. By way of example, a pair of tabs 1120 is formed at respective ends, in the direction parallel to the longitudinal axis L, of the plate-shaped extension portion 112, for example, of each terminal assembly 1.

In an exemplary embodiment, as shown in the figures, in an arrangement as a specific example, each tab 1120 is arranged obliquely to extend outward away from the conductive member 6 toward an inner wall 301 of the terminal accommodating portion 30 of the housing 3 from a respective edge of the terminal base 11, such that, each tab 1120 functions as a stop to prevent a respective terminal assembly 1 from exiting the terminal accommodating portion 30 of the housing 3, in a condition that the two terminal assemblies 1 are mounted in place in the terminal accommodating portion 30 of the housing 3. With this arrangement, during the insertion of the terminal assembly 1 into the terminal accommodating portion 30, the tabs 1120 are pressed without hindering the insertion action; once the terminal assembly 1 is installed in place in the terminal accommodating portion 30, the tabs 1120 return to an expanded, unstressed state to effectively resist withdrawal of the terminal assembly 1.

In the exemplary embodiment, for example, as shown in the figure, in response to the two terminal assemblies 1 being mounted in place in the terminal accommodating portion 30 of the housing 3 without being offset by force, each tab 1120 does not contact the inner wall 301 of the terminal accommodating portion 30; and in response to at least one terminal assembly 1 being displaced in the terminal accommodating portion 30, at least one tab 1120 is urged against the inner wall 301 of the terminal housing 30 and functions as a beam with simply-supported end supporting respective terminal assembly 1 relative to the inner wall 301. Thus, this tab 1120 is in the form of a cantilevered beam. In addition to the snap stop action preventing the terminal assembly 1 from accidentally withdrawing from the housing 3, the pair of tabs 1120 formed at both ends of, for example, the plate-like extension 112 of each terminal assembly 1 in a direction parallel to the longitudinal axis L is compressed to act as a pair of beams with respective simply-supported ends, providing elastic supporting forces to the terminal assembly 1, in particular its plate-like extension 112, against deformation. It can be seen that the tabs 1120 do not always function as elastic supports, but only function as beams with respective simply-supported ends when the terminal assembly 1 is deformed against the wall surface of the housing 3.

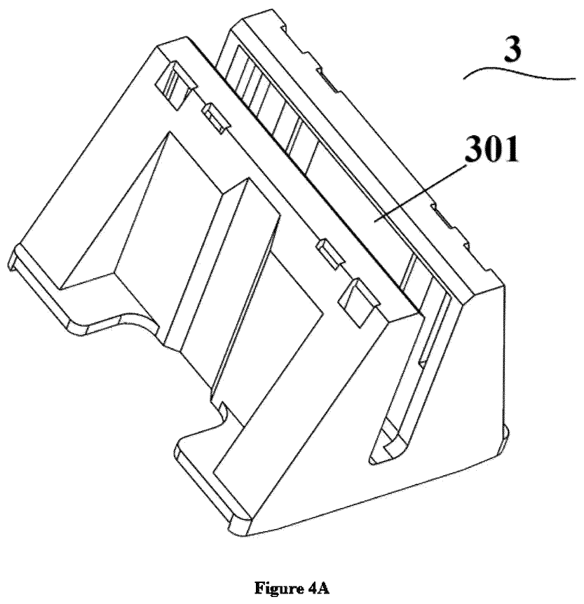

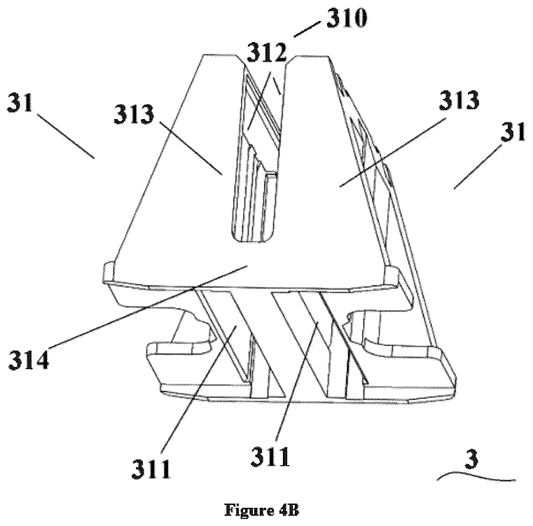

In the exemplary embodiment, FIGS. 4A and 4B respectively illustrate schematic perspective views from different viewing angles of the housing 3 as shown in FIG. 3.

In the exemplary embodiment, according to a typical exemplary embodiment of the present disclosure, for example, as shown in the figures, the housing 3 comprises two bodies 31 disposed opposite each other, the two bodies 31 being spaced apart to define a through cavity 310 which extends along the longitudinal axis L therebetween for insertion of the conductive member 6 and the two bodies 31 being merely connected at respective bottoms thereof, each body 31 being provided with a through-hole portion 311 formed at the respective bottom for insertion of a respective terminal assembly 1, and each body 31 being provided with a recess 312 recessed at a side facing the other body 31, the through-hole portion 311 of each body 31 communicating to respective recess 312 for receiving the respective terminal assembly 1, with respective recesses 312 of the two bodies 31 cooperatively defining the terminal accommodating portion 30.

In the exemplary embodiment, as shown in the figures in a specific exemplary arrangement, the two bodies 31 are connected to each other at respective bottoms, by their respective end walls 313 at both ends along the longitudinal axis L via a transition wall portion 314 therebetween.

As an example, the outer side wall of each main body 31 of the housing 3, facing away from the other main body 31, is further formed with a through slot extending from the top to the bottom to avoid interference with the insertion of threaded fasteners 5 into the plate-shaped base portion 111 of the terminal base 11 for connection to the substrate 4.

Furthermore, upon consideration that the electrical connector 2 provided in another aspect of the present disclosure comprises two aforementioned terminal assemblies 1, and thus it also possesses advantages of the aforementioned terminal assemblies 1, without being repeatedly set forth herein.

The above description of the respective solutions of the terminal assembly 1 and the electrical connector 2 in the foregoing embodiments of the present disclosure is intended to be illustrative, rather than restrictive. Although the present disclosure has been described with reference to the drawings, the embodiments disclosed in the drawings are intended to exemplarily illustrate the preferred implementations of the present disclosure and should not be construed as a limitation thereof.

Therefore, those skilled in the art will understand that the embodiments described above are exemplary, and those skilled in the art can make improvements. Structures described in various embodiments can be modified and freely combined without conflict in structure or principle. Such changes should fall within the protection scope of the present disclosure.

The breadth and scope of the present disclosure should not be limited by any of the above-described exemplary embodiments but should be defined only in accordance with the following claims and their equivalents.

It should be noticed that the wording “comprising” does not exclude other components or steps, and the wording “a/an” or “one” does not exclude multiple or a plurality of. Furthermore, any reference numeral(s) in the claims should not be construed to be limitation of the scope of the present disclosure.

1. A terminal assembly configured to fit with a conductive member to form a conductive contact therebetween, the terminal assembly comprising:
a terminal base; and,
a contact arm having a common base plate fixed to the terminal base, and two sets of contact beams arranged in mirror symmetry with each other relative to a longitudinal axis of the common base plate, each set of contact beams extending from a respective side of the common base plate and being bent back.

2. The terminal assembly of claim 1, wherein respective thicknesses of the terminal base and the contact arm are individually configurable, independently of each other.

3. The terminal assembly of claim 1, wherein respective free ends of the two sets of contact beams are spaced apart from each other.

4. The terminal assembly of claim 3, wherein each set of contact beams comprises a row of contact fingers arranged to be spaced apart from each other along the longitudinal axis, the row of contact fingers being configured to extend from the respective side of the common base plate away from the common base plate, and then bend back, respectively.

5. The terminal assembly of claim 4, wherein respective contact fingers of the two sets of contact beams are equal in quantity, and are disposed opposite each other.

6. The terminal assembly of claim 5, wherein the free ends of the respective contact fingers of the two sets of contact beams are spaced apart from each other.

7. The terminal assembly of claim 6, wherein, respective contact fingers of the two sets of contact beams are arranged in one-to-one alignment with each other; or respective contact fingers of the two sets of contact beams are arranged to be incompletely aligned with each other.

8. The terminal assembly of claim 1, wherein the common base plate and the two sets of contact beams are integrally formed from an electrically conductive material.

9. The terminal assembly of claim 8, wherein the common base plate and the two sets of contact beams are made of sheet metal by a sheet metal process.

10. The terminal assembly of claim 1, wherein the terminal base comprises a plate-shaped base portion extending in a first direction orthogonal to the longitudinal axis and a plate-shaped extension portion bent from the plate-shaped base portion to extend in a second direction at an angle to both the first direction and the longitudinal axis.

11. The terminal assembly of claim 10, wherein the second direction is orthogonal to both the first direction and the longitudinal axis.

12. The terminal assembly of claim 11, wherein both ends of the common base plate of the contact arm along the longitudinal axis are respectively provided with holes for riveting or screwing to the terminal base, the common base plate being fixed to a plate-shaped extension portion of the terminal base via riveting or screwing at the holes.

13. An electrical connector, comprising:
an insulating housing, which is provided with a terminal accommodating portion; and
two terminal assemblies, each terminal assembly being fixed to the insulating housing by snap-fitting to a terminal base in the terminal accommodating portion, respectively, the two terminal assemblies are accommodated in the terminal accommodating portion of the insulating housing and arranged opposite each other, and are electrically connected to both sides of a conductive member which have different potentials or polarities and are interposed between the two terminal assemblies, respectively.

14. The electrical connector of claim 13, wherein each of the two terminal assemblies has a tab, which extends obliquely away from the conductive member toward the insulating housing from respective edge at respective end of both ends of the terminal base in a direction parallel to a longitudinal axis, respectively.

15. The electrical connector of claim 14, wherein each tab is arranged obliquely to extend outward away from the conductive member toward an inner wall of the terminal accommodating portion of the insulating housing from a respective edge of the terminal base, such that, each tab functions as a stop to prevent a respective terminal assembly from exiting the terminal accommodating portion of the insulating housing, in a condition that the two terminal assemblies are mounted in place in the terminal accommodating portion of the insulating housing.

16. The electrical connector of claim 15, wherein, in response to the two terminal assemblies being mounted in place in the terminal accommodating portion of the insulating housing without being offset by force, each tab does not contact the inner wall of the terminal accommodating portion and in response to at least one terminal assembly being displaced in the terminal accommodating portion, at least one tab is urged against the inner wall of a terminal housing and functions as a beam with simply-supported end supporting the respective terminal assembly relative to the inner wall.

17. The electrical connector of claim 13, wherein the insulating housing comprises two bodies disposed opposite each other, the two bodies being spaced apart to define a through cavity which extends along a longitudinal axis therebetween for insertion of the conductive member and the two bodies being merely connected at respective bottoms thereof, each body being provided with a through-hole portion formed at the respective bottom for insertion of a respective terminal assembly, and each body being provided with a recess recessed at a side facing an other body, the through-hole portion of each body communicating to the respective recess for receiving the respective terminal assembly, with respective recesses of the two bodies cooperatively defining the terminal accommodating portion.

18. The electrical connector of claim 17, wherein, the two bodies are connected to each other at the respective bottoms, by their respective end walls at both ends along the longitudinal axis via a transition wall portion therebetween.
